(19) United States
(12) Patent Application Publication
(10) Pub. No.: US 2026/0276912 A1
(43) Pub. Date: Sep. 17, 2026

(54) OPTICAL FIBER POSITIONING DEVICE

(71) Applicant: GlobalFoundries U.S. Inc., Malta, NY (US)

(72) Inventor: Jae Kyu Cho, Niskayuna, NY (US)

(21) Appl. No.: 19/077,622

(22) Filed: Mar. 12, 2025

(51) Int. Cl. G02B 6/42

(52) U.S. Cl. CPC G02B 6/4227; G02B 6/4222; G02B 6/4226

(57) ABSTRACT

The present disclosure relates to an optical fiber positioning device and, more particularly, to an optical fiber positioning device and a method for attaching a fiber optic array to a photonic integrated circuit (PIC). A structure includes: a body having a first end and a second end; at least one reflective surface provided on an upper surface of the body; a light source configured to emit light onto the at least one reflective surface; at least one sensor configured to sense the light reflected from the at least one reflective surface and convert the light into a signal; and a control system configured to receive the signal from the at least one sensor.

### BACKGROUND

The present disclosure relates to an optical fiber positioning device and, more particularly, to an optical fiber positioning device and a method for attaching a fiber optic array to a photonic integrated circuit (PIC).

A photonic integrated circuit (PIC) is a microchip containing two or more photonic components. Examples of a PIC include monolithic tunable lasers, widely tunable lasers, externally modulated lasers and transmitters, integrated receivers, etc. These technologies detect, generate, transport, and process light, and provide functions for information signals imposed on optical wavelengths typically in the visible spectrum or near-infrared.

A commercially utilized material platform for a PIC can be a semiconductor substrate such as indium phosphide (InP), which allows for the integration of various optically active and passive functions on the same chip. The alignment of a fiber optic array to the PIC is important to achieve high performance optical devices. For example, the fiber optic array needs to be aligned in the longitudinal, transversal and diagonal axes to ensure low insertion loss.

### SUMMARY

In an aspect of the disclosure, a structure comprises: a body comprising a first end and a second end; at least one reflective surface provided on an upper surface of the body; a light source configured to emit light onto the at least one reflective surface; at least one sensor configured to sense the light reflected from the at least one reflective surface and convert the light into a signal; and a control system configured to receive the signal from the at least one sensor.

In an aspect of the disclosure, a structure comprises: a body comprising a first end and a second end and composed of a transparent material; a first reflective surface at the first end of the body; a second reflective surface at the second end of the body; a first light sensor receiving light from the first reflective surface and converting the light to a first signal; a second light sensor receiving light from the second reflective surface and converting the light to a second signal; and a control system configured to receive the first signal and the second signal and provide active feedback to adjust a position of the body on a substrate.

In an aspect of the disclosure, a method comprises: emitting light onto a first reflective surface and a second reflective surface of a body; reflecting the light from the first reflective surface and the second reflective surface onto respective light sensors which convert the light into signals; and providing the signals to a control system which uses the signals to provide active feedback to a pick-up tool which adjusts placement of the body onto a substrate.

### BRIEF DESCRIPTION OF THE DRAWINGS

The present disclosure is described in the detailed description which follows, in reference to the noted plurality of drawings by way of non-limiting examples of exemplary embodiments of the present disclosure.

FIG. 1 shows a top view of an optical fiber positioning device in accordance with aspects of the present disclosure.

FIG. 2 shows an exploded view of the optical fiber positioning device, a fiber optical array and a substrate in accordance with aspects of the present disclosure.

FIG. 3 shows an assembly and method of use of the optical fiber positioning device coupling the fiber optical array to the substrate in accordance with aspects of the present disclosure.

FIG. 4 shows a control system in accordance with aspects of the present disclosure.

### DETAILED DESCRIPTION

The present disclosure relates to an optical fiber positioning device and, more particularly, to an optical fiber positioning device and a method for attaching a fiber optic array to a photonic integrated circuit (PIC). More specifically, the optical fiber positioning device comprises a transparent glass, plastic or a polymer coupon or lid with reflective surfaces at opposing ends (e.g., longitudinal ends). In further embodiments, the optical fiber positioning device may be material with low coefficient of thermal expansion to ensure consistent alignment with varying temperature condition. In embodiments, the reflective surfaces may be a mirror or other reflective coating used to assist in achieving highly reliable parallelism between the fiber optic array and the waveguide in the PIC. For example, the reflective surfaces in combination with photodetectors or other sensors and a control system provide active feedback to make adjustments of the optical fiber positioning device, thereby ensuring parallelism between a multi-channel fiber array positioned within grooves (e.g., V-shape grooves of a PIC) and a waveguide of the PIC.

Advantageously, the optical fiber positioning device prevents longitudinal/transversal tilt of a fiber optic array in V-grooves of a PIC to ensure proper alignment to a waveguide structure, thereby resulting in low insertion loss. Additionally, the optical fiber positioning device is cost effective and makes it possible to provide quick adjustments allowing optimal fiber alignment in the V-grooves of the PIC. The optical fiber positioning device is also a flexible tool which can be used with both small and high count fiber optic arrays, and which is easily adopted within existing fiber attach tools (e.g., pick and place tool). Moreover, the active feedback can be used to automate adjustments of the fiber positioning device to obtain parallelism between the fiber optic array and the waveguide in the PIC. For example, the automated adjustments using the active feedback can include six independent axes of motion.

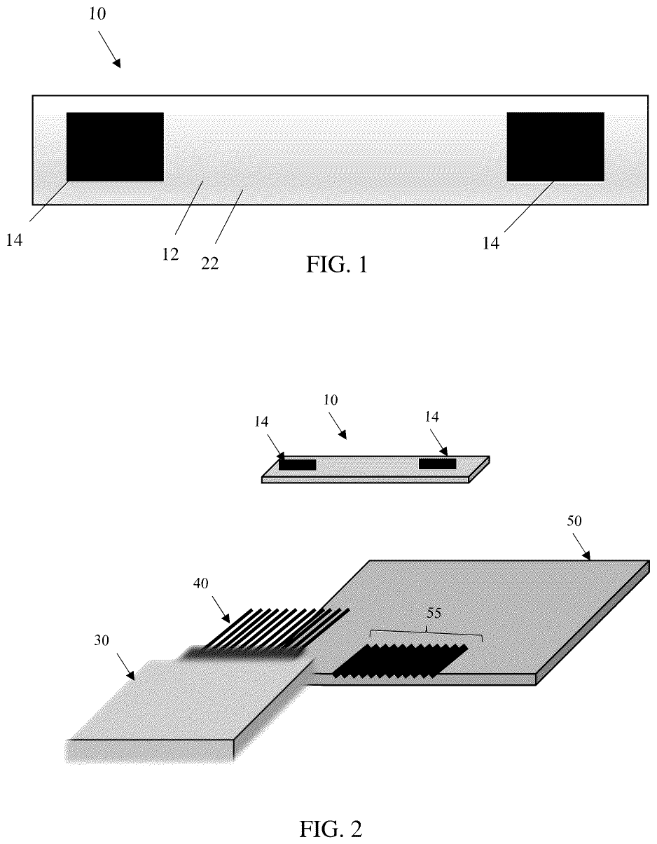

FIG. 1 shows a top view of an optical fiber positioning device in accordance with aspects of the present disclosure. More specifically and referring to FIG. 1, the optical fiber positioning device 10 may include a body (e.g., lid or coupon) 12 with one or more reflective surfaces 14. In more specific embodiments, the reflective surfaces 14 may be a mirror or other reflective surface provided at opposing ends (e.g., opposing longitudinal ends) of the body 12. In embodiments, the reflective surfaces 14 may be, for example, any surface that reflects light in a specific direction. For example, the reflective surfaces 14 may be a mirror, a glass with a different refractive index than the body 12 or polished metals.

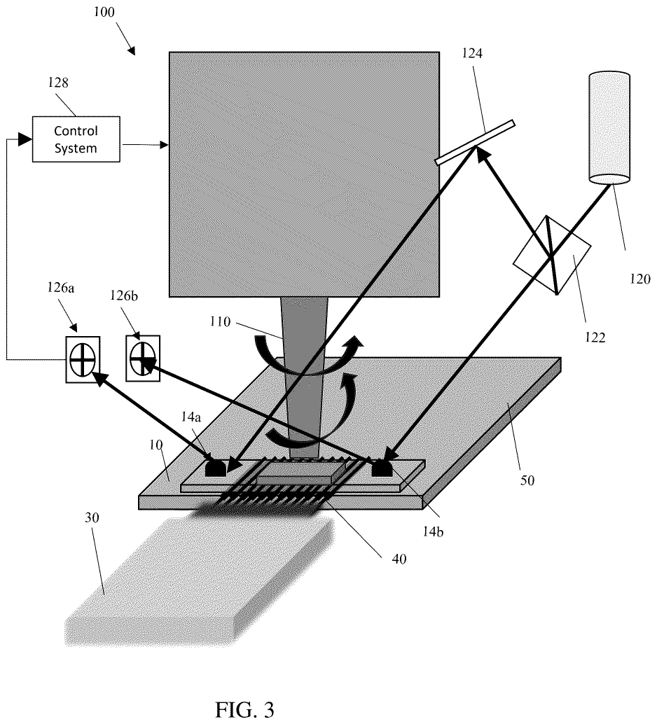

The body 12 may be composed of glass, plastic, polymer or other transparent materials. The transparent material allows an engineer or technician to visualize the underlying the fiber optic array positioned on a PIC during an assembly process. The body 12 of the optical fiber positioning device 10 may include a flat, bottom surface and a flat, planar top surface. The flat, planar bottom surface of the optical fiber positioning device 10 may sit flush on a top surface of a substrate, e.g., PIC, as shown in FIGS. 2 and 3.

The reflective surfaces 14 may be any appropriate shape such as a polygon, e.g., rectangular, square, hexagonal, octagonal, or round, oval or other shape. In any of these configurations, the reflective surfaces 14 are configured to reflect light from a light source, e.g., laser, to a sensor as shown in FIG. 3. For example, the reflective surfaces 14 may comprise a mirror which is capable of reflecting light from a laser and/or beam splitter to a photodetector.

FIG. 2 shows an exploded view of the optical fiber positioning device 10, a fiber optical array 30 and a substrate 50, e.g., PIC. In embodiments, the fiber optical array 30 includes a plurality of fiber optics 40 which are placed and aligned within V-grooves 55 located on an upper surface of the substrate 50. In embodiments, the substrate 50 may be a PIC board, as an example.

The fiber optics 40 of the fiber optic array 30 may be attached to the optical fiber positioning device 10 during the assembly process. The optical fiber positioning device 10 is then lowered onto the substrate 50 such that the individual fiber optics of the fiber optical array 30 are aligned within the V-grooves 55 of the substrate 50. In embodiments, the alignment is along longitudinal, traverse and diagonal axes. The alignment can be accomplished by using the combination of the reflective surfaces 14, sensors 126a, 12b and a control system 128 as shown in FIG. 3.

FIG. 3 shows the optical fiber positioning device 10 coupling the fiber optical array 40 to the substrate 50 and methods of use in accordance with aspects of the present disclosure. In this representation, the optical fiber positioning device 10 may be attached to a pick and place tool 100 and, more specifically, to a push-pin 110 of the pick and place tool 100. The pick and place tool 100 and the push-pin 110 may be any conventional tool known to those of skill in the art. As should be understood by those of skill in the art, the push-pin 110 is capable of six-degrees of freedom, where the six-degrees of freedom refer to a complete range of movement encompassing three translational motions (moving along X, Y, and Z axes) and three rotational motions (pitch, yaw, and roll) around those axes.

The optical fiber positioning device 10 may be secured to the push-pin 110 by a vacuum device or by another known method. Also, the optical fiber positioning device 10 may be secured to the substrate 50 by UV-curable glue, for example, to confine the fiber optical array 30 in an optimal position. The pick and place tool 100 can be adjusted in six independent axes of motion (e.g., different angles).

A light source 120 may be adjacent to the pick and place tool 100. The light source 120 may be, for example, a laser or other light source that is capable and positioned to emit focused light (represented by the arrows) onto a beam splitter 122 and, in turn, the reflective surfaces 14a, 14b. In embodiments, the beam splitter 122 will direct the light to a mirror or other reflective surface 124 (e.g., polished metal coating) which, in turn, is positioned to reflect the light to one of the reflective surface 14a, 14b on the optical fiber positioning device 10. In this way, both reflective surfaces 14a, 14b will receive light from the light source 120.

In embodiments, the beam splitter 122 may be any known beam splitter. For the example, the beam splitter 122 may comprise two triangular glass prisms which are glued together at their base using polyester, epoxy, or urethane-based adhesives. The thickness of the resin layer is adjusted such that for a certain wavelength half of the emitted light incident through one “port” (i.e., face of the cube) is reflected towards a mirror 124 and the other half is transmitted to the reflective surface 14b. The direction of reflection is typically orthogonal to the surface of the beam splitter 122; although other angles are contemplated herein depending on the type of beam splitter 122 implemented with the system described herein.

Other beam splitters may be, for example, polarizing beam splitters, e.g., Wollaston prism, which use birefringent materials to split light into two beams of orthogonal polarization states are also contemplated herein. Moreover, it should be understood by those of skill in the art that other types of beam splitters, e.g., using a dichroic optical coating, are also contemplated herein and that the above examples should not be considered limiting features of the present disclosure.

The reflective surfaces 14a, 14b direct the light onto respective sensors 126a, 126b. In embodiments, the sensors 126a, 126b may be photodetectors, photosensors or photodiodes. It should be understood by those of skill in the art that photodetectors, photosensors or photodiodes convert light into an electrical signal, which is representative of the position of the optical fiber positioning device 10 with respect to the substrate 50 (based on the location of the light hitting the surface of the sensors 126a, 126b).

The signal, in turn, is provided to a control system 128. The control system 128 may use the signal to determine whether the positioning of the optical fiber positioning device 10 on the substrate 50 is in a proper placement such that there is accurate parallelism between the multi-channel fiber array in the V-grooves and the waveguide in a PIC. For example, if the light hits the surface of the sensors 126a, 126b at a predetermined location, it can be determined from the control system 128 that the optical fiber positioning device 10 is properly positioned on the substrate 50. In this case, if the positioning is proper, no further action is required.

On the other hand, the control system 128 may determine that the light sensed by the sensors 126a, 126b would not result in the required optimal placement of the optical fiber positioning device 10, e.g., the fiber optic arrays are not perfectly positioned, longitudinally, transversely and diagonally (e.g., within six degrees of freedom) within the V-grooves of the substrate 50, e.g., board of a PIC. For example, if the light hit the surface of the sensors 126a, 126b outside of the predetermined location, it can be determined that the optical fiber positioning device 10 is not properly positioned on the substrate 50.

In this latter case, the control system 128 may calculate the required movements needed of the pick and place tool 100 and, more specifically, the push-pin 110 of the pick and place tool 100, to accurately position the optical fiber positioning device 10. Accordingly, the control system 128 can provide active feedback to adjust the pick and place tool 100 and, more specifically, the push-pin 110 to optimally place the optical fiber positioning device 10 onto the substrate 50. More specifically, in this way, the control system 128 provides active feedback to achieve parallelism between the multi-channel fiber array in the V-grooves and the waveguide in the PIC. In embodiments, a verification of proper alignment may be made to by repeating the steps as already described herein.

It should be recognized that prior to use, the respective sensors 126a, 126b and control system 128 may be calibrated to determine what location the light reflected from the reflective surfaces 14a, 14b must hit on the respective sensors 126a, 126b to achieve the proper alignment of the optical fiber positioning device 10 for the required parallelism. With this calibration, the control system 128 may calculate how to adjust the optical fiber positioning device 10 when there is improper alignment. For example, the control system 128 may make geometric calculations to determine the required movements/adjustments required of the optical fiber positioning device 10 in proper alignment, e.g., adjustments so that light reflecting off the reflective surfaces 14a, 14b would hit the respective sensors 126a, 126b in the location that is known to place the optical fiber positioning device 10.

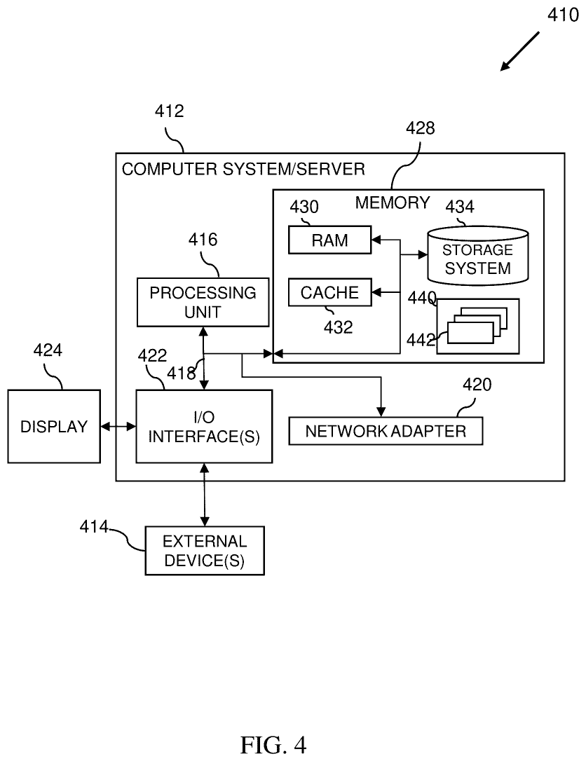

FIG. 4 shows a representative control system 128. In embodiments, the control system 128 comprises a cloud computing node according to an embodiment of the present disclosure. In this regard, the present disclosure may be representative of a system, a method, and/or a computer program product at any possible technical detail level of integration. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages. The computer readable program instructions may execute entirely on the user's computer, partly on the user's computer, as a stand-alone software package, partly on the user's computer and partly on a remote computer or entirely on the remote computer or server.

As described in more detail with respect to FIG. 4, these computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

Referring now to FIG. 4, a schematic of an example of a cloud computing node is shown. Cloud computing node 410 is only one example of a suitable cloud computing node and is not intended to suggest any limitation as to the scope of use or functionality of embodiments of the disclosure described herein. Regardless, cloud computing node 410 is capable of being implemented and/or performing any of the functionality set forth hereinabove. Also, it is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

In cloud computing node 410 there is a computer system/server 412, which is operational with numerous other general purpose or special purpose computing system environments or configurations. In embodiments, the computer system/server 412 (which may be internal or external to a processing tool) may perform the functions described herein, including, for example, (i) obtaining nozzle images from a camera, (ii) analyzing the nozzle images and identifying nozzle faults using imaging default detection, and (iii) interlocking the faults by, for example, notifications, tool inhibits, and/or lot holding processes.

Computer system/server 412 may be described in the general context of computer system executable instructions, such as program modules, being executed by a computer system. Generally, program modules may include routines, programs, objects, components, logic, data structures, and so on that perform particular tasks or implement particular abstract data types. Computer system/server 412 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 412 in cloud computing node 410 is shown in the form of a general-purpose computing device. The components of computer system/server 412 may include, but are not limited to, one or more processors or processing units 416, a system memory 428, and a bus 418 that couples various system components including system memory 428 to processor 416.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 412 typically includes a variety of computer system readable media. Such media may be any available media that is accessible by computer system/server 412, and it includes both volatile and non-volatile media, removable and non-removable media.

System memory 428 can include computer system readable media in the form of volatile memory, such as random access memory (RAM) 430 and/or cache memory 432. Computer system/server 412 may further include other removable/non-removable, volatile/non-volatile computer system storage media. By way of example only, storage system 434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 418 by one or more data media interfaces. As will be further depicted and described below, memory 428 may include at least one program product having a set (e.g., at least one) of program modules that are configured to carry out the functions of embodiments of the disclosure.

Program/utility 40, having a set (at least one) of program modules 42, may be stored in memory 428 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 412 may also communicate with one or more external devices 414 such as a keyboard, a pointing device, a display 424, etc.; one or more devices that enable a user to interact with computer system/server 412; and/or any devices (e.g., network card, modem, etc.) that enable computer system/server 412 to communicate with one or more other computing devices. Such communication can occur via Input/Output (I/O) interfaces 422. Also, computer system/server 412 can communicate with one or more networks such as a local area network (LAN), a general wide area network (WAN), and/or a public network (e.g., the Internet) via network adapter 420. As depicted, network adapter 420 communicates with the other components of computer system/server 412 via bus 418. It should be understood that although not shown, other hardware and/or software components could be used in conjunction with computer system/server 412. Examples, include, but are not limited to: microcode, device drivers, redundant processing units, external disk drive arrays, RAID systems, tape drives, and data archival storage systems, etc.

As should be understood by those of skill in the art, a cloud computing environment includes one or more cloud computing nodes 410 with which local computing devices used by cloud consumers. Nodes 410 may communicate with one another. They may be grouped (not shown) physically or virtually, in one or more networks, such as Private, Community, Public, or Hybrid clouds as described hereinabove, or a combination thereof. This allows cloud computing environment to offer infrastructure, platforms and/or software as services for which a cloud consumer does not need to maintain resources on a local computing device. The model described herein may be scalable with the cloud computing environment.

The optical fiber positioning device can be utilized to fabricate integrated circuits in system on chip (SoC) technology. The SoC is an integrated circuit (also known as a “chip”) that integrates all components of an electronic system on a single chip or substrate. As the components are integrated on a single substrate, SoCs consume much less power and take up much less area than multi-chip designs with equivalent functionality. Because of this, SoCs are becoming the dominant force in the mobile computing (such as in Smartphones) and edge computing markets. SoC is also used in embedded systems and the Internet of Things.

The method(s) and tool as described above are used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A structure comprising:
a body comprising a first end and a second end;
at least one reflective surface provided on an upper surface of the body;
a light source configured to emit light onto the at least one reflective surface;
at least one sensor configured to sense the light reflected from the at least one reflective surface and convert the light into a signal; and
a control system configured to receive the signal from the at least one sensor.

2. The structure of claim 1, wherein the body comprise transparent material.

3. The structure of claim 2, wherein the transparent material comprises one of glass, plastic and polymer.

4. The structure of claim 2, wherein the at least one reflective surface comprises a first reflective surface at the first end of the body and a second reflective surface at the second end of the body.

5. The structure of claim 2, wherein the at least one reflective surface comprises a mirror.

6. The structure of claim 4, further comprising a beam splitter configured to split the light such the first reflective surface and the second reflective surface receive the light which is to be reflected to the at least one sensor.

7. The structure of claim 6, further comprising a reflective surface positioned between the beam splitter and the first reflective surface and which is configured to reflect the light to the first reflective surface.

8. The structure of claim 6, wherein the at least one sensor comprises a first photodetector and a second photodetector, the first reflective surface reflecting the light to the first photodetector and the second reflective surface reflecting the light to the second photodetector.

9. The structure of claim 1, wherein the light source comprises a laser.

10. The structure of claim 7, further comprising a pick and place tool configured to pick up and position the body onto a substrate and receive active feedback from the control system.

11. The structure of claim 10, wherein the control system provides the active feedback to the pick and place tool to adjust placement of the body on the substrate within six independent axes of motion.

12. A structure comprising:
a body comprising a first end and a second end and composed of a transparent material;
a first reflective surface at the first end of the body;
a second reflective surface at the second end of the body;
a first light sensor receiving light from the first reflective surface and converting the light to a first signal;
a second light sensor receiving light from the second reflective surface and converting the light to a second signal; and
a control system configured to receive the first signal and the second signal and provide active feedback to adjust a position of the body on a substrate.

13. The structure of claim 12, wherein the first reflective surface and the second reflective surface comprise a first mirror and a second mirror.

14. The structure of claim 13, further comprising a light source and a beam splitter, the light source being positioned to emit the light onto the beam splitter which is reflected to the first reflective surface.

15. The structure of claim 14, wherein the light source comprises a laser.

16. The structure of claim 14, further comprising a mirror between the beam splitter and first reflective surface, the mirror configured to reflect the light received from the beam splitter to the first reflective surface.

17. The structure of claim 16, wherein the first light sensor and the second light sensor comprise photodetectors.

18. The structure of claim 17, wherein the control system receives the signal from the photodetectors and uses the signal to provide the active feedback to a pick and place tool.

19. The structure of claim 12, wherein the active feedback from the control system comprises instructions for six independent axes of motion of the pick and place tool based on a current position of the body on the substrate.

20. A method comprising:
emitting light onto a first reflective surface and a second reflective surface of a body;
reflecting the light from the first reflective surface and the second reflective surface onto respective light sensors which convert the light into signals; and
providing the signals to a control system which uses the signals to provide active feedback to a pick and place tool which adjusts placement of the body onto a substrate.
